(19) United States
(12) Patent Application Publication
(10) Pub. No.: US 2002/0009244 A1
(43) Pub. Date: Jan. 24, 2002

(54) Bearing arrangement for a radial piston pump

(76) Inventor: Jorg Temme, Harsewinkel (DE)

Correspondence Address: Michael Best & Friedrich LLP, 942 Memorial Parkway, Phillipsburg, NJ, 08865, US

(21) Appl. No.: 09/861,255

(22) Filed: May 18, 2001

(30) Foreign Application Priority Data
May 18, 2000 (DE) 100 24 541.2

(51) Int. Cl. F16C 19/50

(52) U.S. Cl. 384/447

(57) ABSTRACT

The bearing arrangement for a radial piston pump is designed as a structural unit in which a pump shaft with at least one shaft bearing and with an eccentric ring with an eccentric bearing running thereon are together arranged in a bush which surrounds these components and can be fitted into a pump block.

### BACKGROUND OF THE INVENTION

The invention relates to a bearing arrangement according to the preamble of patent claim 1.

A bearing arrangement of this type is known from DE 43 04 390 A1 and DE 197 11 557 A1. According to these two documents, the parts of the bearing arrangement are fitted into a housing individually. The eccentric part is formed by a shaft projection which runs eccentrically with respect to the longitudinal axis of the pump shaft, i.e. is formed integrally with the pump shaft. The pump shaft is mounted in the housing by a rolling bearing (ball bearing). On the eccentric shaft projection there is a rolling bearing (needle bearing), on the outer ring of which a plurality of pump pistons which are arranged in the pump housing and extend radially with respect to the pump shaft are supported.

The bearing arrangement therefore comprises a plurality of individual parts which have to be fitted separately. Such bearing arrangements are used, for example, for radial piston pumps in ABS systems for vehicle brakes or in high-pressure cleaning equipment. There are also other applications for radial piston pumps.

The invention is based on the object of, instead of having a bearing arrangement which has to be assembled as individual parts in the pump housing, designing this arrangement as a compact structural unit which is ready for installation.

According to the invention, this object is achieved by means of the design described in patent claim 1.

The foregoing illustrates limitations known to exist in present devices and methods. Thus, it is apparent that it would be advantageous to provide an alternative directed to overcoming one or more of the limitations set forth above. Accordingly, a suitable alternative is provided including features more fully disclosed hereinafter.

### SUMMARY OF THE INVENTION

According to this design, all the principal components of the bearing arrangement are arranged together in a bush which surrounds these parts and as such is ready for installation, simply having to be fitted into the pump housing or the pump block.

Further details and advantages of the invention are given in the subclaims and the following detailed description.

### BRIEF DESCRIPTION OF THE DRAWINGS

Two exemplary embodiments of the invention are described below with reference to the drawings, in which:

FIG. 1 shows a diagrammatic cross-sectional view of an example of a bearing arrangement, fitted in a pump lock;

FIG. 2 shows a diagrammatic sectional view of another exemplary embodiment of a bearing arrangement, fitted in a pump block; and

FIG. 3 shows a sectional view on line B-B from FIG. 2.

### DETAILED DESCRIPTION

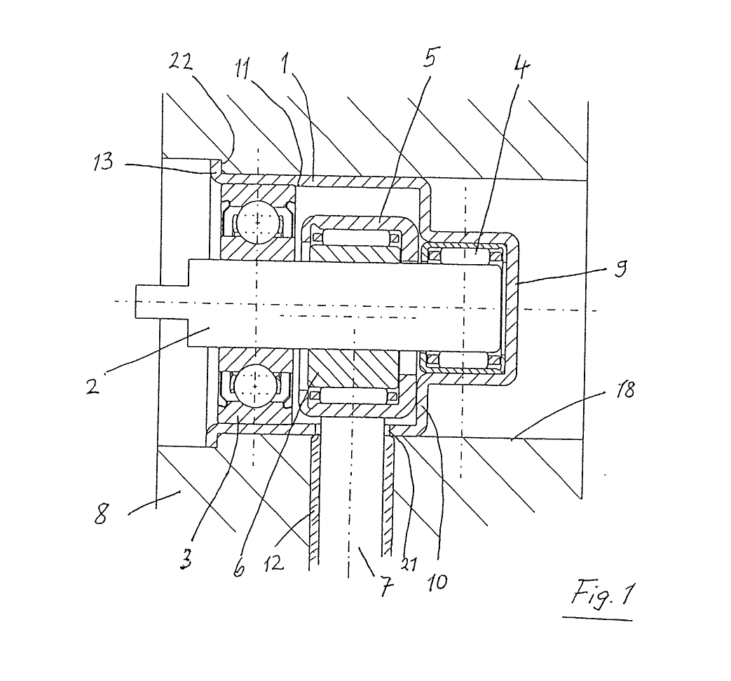

As shown in FIG. 1, the bearing arrangement, which is designed as a structural unit, firstly has an outer bush 1 which is preferably made from deep-drawn and hardened steel. A pump shaft 2 is mounted in the bush 1 by means of a ball bearing 3 (radial ball bearing) at the open end of the bush 1 and by means of a further rolling bearing 4 (needle bearing) at the opposite end of the bush 1. At this end, the bush has a bush base 9, against which the outer ring of the needle bearing 4 bears. Both the ball bearing 3 and the needle bearing 4 are fitted into the bush 1 in the axial direction and are held therein by an interference fit or press fit, between the corresponding bearing outer ring and the inner wall of the bush 1.

The pump shaft 2 is of cylindrical design over substantially its entire length. It may be produced as an extruded part.

An eccentric ring 6 is pressed onto the pump shaft 2 between the two bearings 3 and 4 and is in turn surrounded by a further rolling bearing 5 (needle bearing or eccentric bearing). By way of its outer ring, the eccentric bearing 5 is supported on a step 10 of the bush 1 in the axial direction. The ball bearing 3 (grooved ball bearing) is pressed onto a small step 11 in the bush 1 in the axial direction. Consequently, the pump shaft 2 is supported on both sides of the eccentric ring 6 and the eccentric bearing 5 by in each case at least one shaft bearing 3, 4. By way of its outer ring, the eccentric bearing 5 is supported axially by the inner ring of the drive-side shaft bearing 3 (grooved ball bearing), and on the other side, by way of its outer ring, it is supported on the step 10 of the bush 1. Consequently, not only the positions of the two shaft bearings 3 and 4, but also the position of the eccentric bearing 5, are defined.

The resultant bearing arrangement is designed as a structural unit and is fitted in its entirety into a bore 18 in a pump housing or pump block 8, in particular is pressed in with an interference fit (press fit). In its wall, the bush 1 has at least one aperture 21 in the region of the outer ring of the eccentric bearing 5. In the fitted position, a pump piston or pump plunger 7 penetrates radially through this aperture 21 and is supported on the outer ring of the eccentric bearing 5. The pump piston or pump plunger 7 is guided in a bush 12 which has been fitted into the pump block 8 and extends in the radial direction with respect to the bush 1 and its rolling bearings. In the drawing shown in FIG. 1, only one such arrangement is shown. However, in radial piston pumps it is also possible for a plurality of pump plungers 7 to be arranged around the eccentric bearing 5 in a star shape, in the manner described above.

At its open end, the bush 1 is fixed and held in the axial direction against a step 22 of the pump block 8, by means of a flange 13. In addition to the interference fit of the bush 1 in the pump block 8, the bush 1 can additionally be secured against twisting in the bush 1 by this flange 13.

This is particularly important at relatively high operating temperatures, when different thermal expansions take place between the pump block 8 and the bush 1, which could cause the bush 1 to come loose in the pump block 8. In particular because the bush 1 accommodating the support bearings 3, 4 preferably consists of steel and therefore provides good support for the two shaft bearings 3 and 4 and the eccentric bearing 5, it is conversely possible for the pump block 8 to consist of lightweight metal. In this case, in the event of different thermal expansions, it would at most be possible for the bush 1 to become freer in the pump block 8, whereas the support bearings 3 and 4 inside the bush 1 could not become free. In this case, the flange 13 prevents the bush 1 from twisting.

At the drive-side (left-hand) end of the pump shaft 2, the driving torque from a drive motor is absorbed via the end side of the shaft 2. In the event of rotation of the pump shaft 2, the radially arranged pump piston(s) 7 is/are moved in a reciprocating manner via the eccentric ring 6 and the eccentric bearing 5, in order to execute the desired action of the radial piston pump.

Because of its shape, the bush 1 is extremely rigid, in particular flexurally rigid. It provides good support in particular also for the needle bearing 4. Nevertheless, any angle errors or incorrect alignments caused by bending of the pump shaft 2 can be compensated for by the resilient mounting of the bush 1, thus ensuring that the pump plungers 7 and therefore the radial piston pump operate correctly.

As shown, the shaft bearing 4 and/or the eccentric bearing 5 are preferably designed as needle bearings without an inner ring (needle bush).

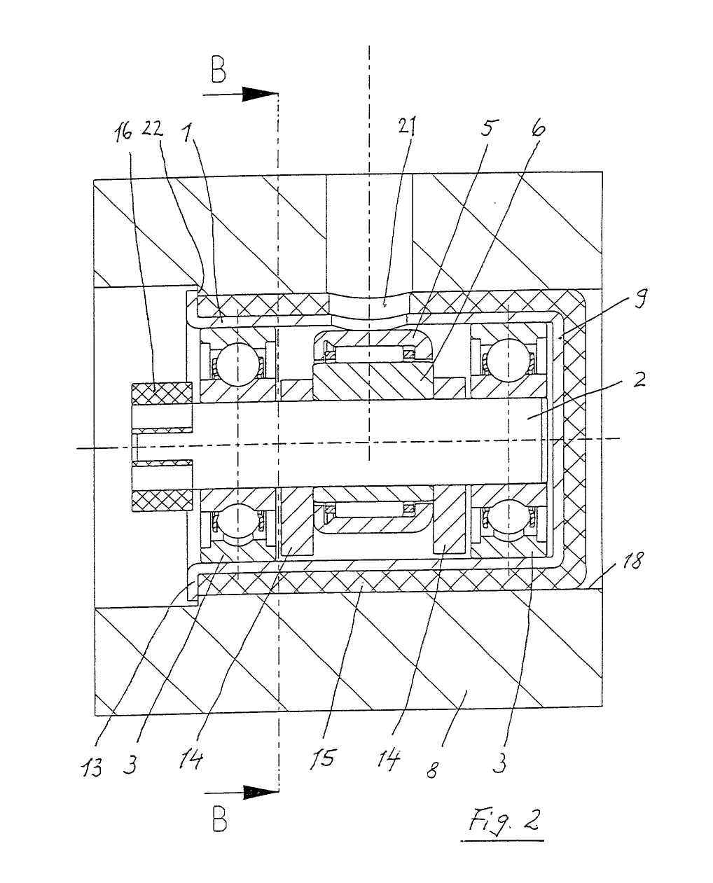

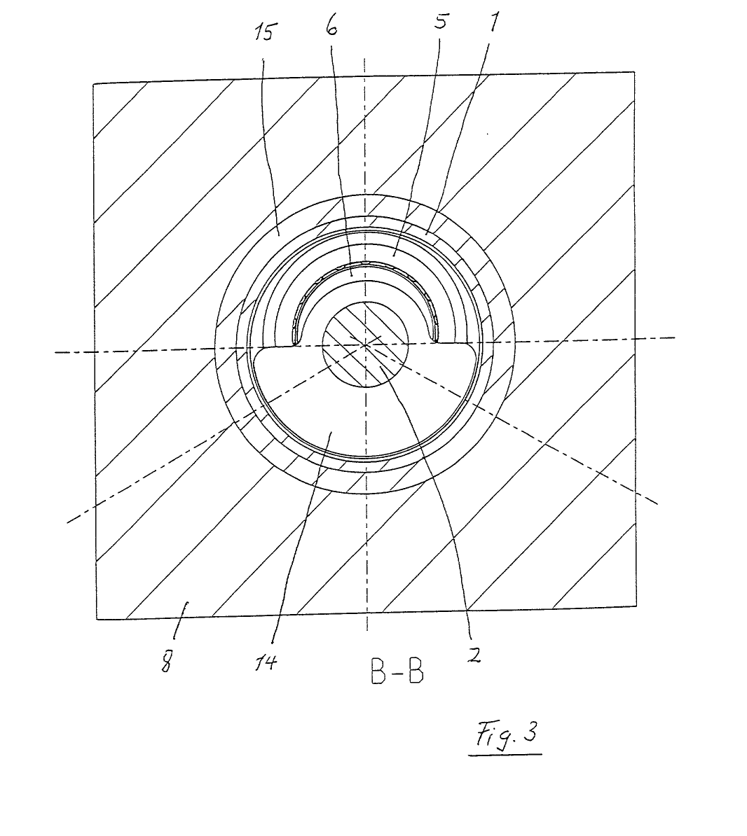

FIGS. 2 and 3 illustrate a further exemplary embodiment of the bearing arrangement. Identical parts to those in the exemplary embodiment shown in FIG. 1 are provided with the same reference numerals in these figures. Only the differences between the embodiment shown in FIGS. 2 and 3 and that shown in FIG. 1 are described below.

The bush 1 is in this case a continuous cylinder. Instead of the needle bearing 4 from FIG. 1, in this case a second radial grooved ball bearing 3 is used, which is pressed into the bush 1 and is supported on the bush base 9. This shaft bearing 3 therefore has the same diameter as the first shaft bearing 3 arranged on the drive-side end of the pump shaft 2. Both shaft bearings 3 are pressed into the bush 1 with an interference fit. An arrangement with only one shaft bearing 3 would also be conceivable.

As shown in FIGS. 2 and 3, a counterweight 14 is in each case arranged between the eccentric ring 6 and the axially adjoining shaft bearing 3, in order to compensate for the inertia forces which arise when the radial piston pump is operating due to the revolving eccentric ring 6. The counterweights 14 are pressed onto the pump shaft 2. It would be sufficient to provide only one counterweight 14. The eccentric bearing 5 runs axially onto the balancing weight(s) 14.

As also shown in FIGS. 2 and 3, a resilient insert 15, in particular in the form of a plastic bush, is arranged between the bush 1 and the pump block 8. Therefore, the bearing arrangement accommodated in the bush 1 is fitted or pressed into the pump block 8 as a structural unit together with this elastic insert 15. This results, firstly, in a bearing unit which is insensitive to bending of the pump shaft 2. Secondly, noise caused during operation of the radial piston pump is silenced, which is advantageous in particular in connection with the two ball bearings 3. The overall result is therefore a bearing arrangement which has a long service life and a high level of reliability.

Finally, an elastic coupling 16 for transmitting the driving torque may be provided on a shaft projection at the drive-side end of the pump shaft 2, which also silences noise and enables bending in the drive train to be absorbed without causing any damage.

Having described the invention, what is claimed is:

1. A bearing arrangement for a radial piston pump, having a rotatably mounted pump shaft which bears an eccentric part on which a rolling bearing, in particular a needle bearing, is arranged, on the outer ring of which at least one pump piston, which is arranged in a pump block and extends radially with respect to the pump shaft, can be supported, wherein the pump shaft, by means of at least one shaft bearing, and the eccentric part, by means of its rolling bearing (eccentric bearing) are together arranged as a structural unit in a bush which surrounds these components and can be fitted into the pump block.

2. The bearing arrangement as claimed in claim 1, wherein the bush of the structural unit can be fitted into the pump block with an interference fit (press fit).

3. The bearing arrangement as claimed in claim 1, wherein the pump shaft is of substantially cylindrical design, and wherein the eccentric part is designed as an eccentric ring and is pressed onto the pump shaft.

4. The bearing arrangement as claimed in claim 1, wherein the pump shaft is supported on both sides of the eccentric part and the eccentric bearing by in each case at least one shaft bearing which is arranged in the bush.

5. The bearing arrangement as claimed in claim 4, wherein the shaft bearing(s) is/are pressed into the bush.

6. The bearing arrangement as claimed in claim 4, wherein a ball bearing, in particular a grooved ball bearing, is provided on one side of the eccentric part as the shaft bearing, and a needle bearing, in particular a needle bearing without an inner ring (needle bush), is provided on the other side of the eccentric part as the shaft bearing.

7. The bearing arrangement as claimed in claim 6, wherein the needle bearing is provided opposite a base of the bush at the opposite end from the drive side of the pump shaft.

8. The bearing arrangement as claimed in claim 6, wherein the ball bearing is pressed onto a step of the bush.

9. The bearing arrangement as claimed in claim 1, wherein the eccentric bearing is supported in the axial direction on one side by the inner ring of the drive-side shaft bearing (grooved ball bearing and on the other side by a step of the sleeve.

10. The bearing arrangement as claimed in claim 4, wherein on both sides of the eccentric part in each case at least one ball bearing, in particular a grooved ball bearing, is provided as the shaft bearing.

11. The bearing arrangement as claimed in claim 10, wherein the two shaft bearings have identical diameters, and wherein the bush is cylindrical over substantially its entire length.

12. The bearing arrangement as claimed in claim 10, wherein the two shaft bearings are pressed into the bush with an interference fit.

13. The bearing arrangement as claimed in claim 1, wherein at least one counterweight to balance the inertia forces is arranged between the eccentric part and the shaft bearing(s) arranged axially next to it.

14. The bearing arrangement as claimed in claim 13, wherein the eccentric bearing runs axially onto the compensating weight(s).

15. The bearing arrangement as claimed in claim 1, wherein the eccentric bearing is a needle bearing without an inner ring (needle bush).

16. The bearing arrangement as claimed in claim 1, wherein a resilient insert, in particular made from plastic, is arranged between the bush and the pump block.

17. The bearing arrangement as claimed in claim 1, wherein an elastic coupling is provided on the drive-side end of the pump shaft.

18. The bearing arrangement as claimed in claim 1, wherein the bush is made from drawn and hardened steel.

19. The bearing arrangement as claimed in claim 1, wherein the pump block consists of lightweight metal.

20. The bearing arrangement as claimed in claim 1, wherein the bush is held on the pump block in the axial direction and/or secured against rotation by means of a flange.

21. The bearing arrangement as claimed in claim 1, wherein the pump shaft is produced as an extruded part.
